(19) United States
(12) Patent Application Publication
(10) Pub. No.: US 2005/0033995 A1
(43) Pub. Date: Feb. 10, 2005

(54) System and method for utilizing information in publicly broadcast signals for shared secret purposes

(76) Inventors: Paul Lin, Fremont, CA (US); Henry Hon, Berkeley, CA (US)

Correspondence Address: Aiello Patent Prosecution, 4911 Pony Pass Circle, San Jose, CA, 95136, US

(21) Appl. No.: 10/913,828

(22) Filed: Aug. 6, 2004

Related U.S. Application Data
(60) Provisional application No. 60/493,907, filed on Aug. 8, 2003.

(51) Int. Cl. H04L 9/32

(52) U.S. Cl. 713/202

(57) ABSTRACT

A system and method for utilizing information in publicly broadcast signals is provided. Information in publicly broadcast signals is utilized as a synchronization source for shared secret purposes, such as challenge and response. Such information may relate to time. Suitable publicly broadcast information may include GPS and atomic clock information. The system includes a token and a server that are capable of generating responses based on broadcast information and other information. The token and server must be able to receive publicly broadcast information via known methods. Both the token and server receive information from a designated source of publicly broadcast signals. The information received by the token is identical to the information received by the server and can be used as a challenge. The token generates a response to the challenge. The token's response is provided to the server. The server can verify that the response to the challenge received from the token is in fact generated by that unique token. If the response to the challenge is verified by the authentication server, the token is identified and authenticated.

### CROSS-REFERENCE TO RELATED APPLICATIONS

This application is a non-provisional application of Provisional Application No. 60/493,907, filed on Aug. 8, 2003.

### BACKGROUND OF THE INVENTION

1. Field of the Invention

The present invention relates to data authentication methods and systems and, more particularly, to a system and method for utilizing publicly broadcast signals for shared secret purposes.

2. Background Information

Many computer network authentication systems require a method of synchronization between a client token and a server. The client token, or token, and server are typically synchronized utilizing one of three known methods. These synchronization methods include counter-based synchronization, time-based synchronization, and challenge-response based synchronization. All three methods rely on incremental values that are available to the token, to the server, or to both.

In counter-based synchronization methods, the token is usually incremented when a user, or client, activates the token, typically by momentarily depressing a button on the token. Upon activation, the token generates a response. The token's response is calculated using a formula based on a seed value and a changing counter value. When the counter value changes incrementally, the token's response also changes.

For authentication, the server calculates its response using a last known counter value. If the token's response does not match the server's response, the server will continue to calculate ahead within a predetermined synchronization range and generate a set of responses. If the token's response matches a value within a set of responses, the response by the token is valid and the token response is authenticated by the server.

For example, assume a last known counter value is five and a predetermined synchronization range is twenty. During the authentication process, the server calculates a response from five to twenty. Assume at counter twenty, the token and server responses match. The token response is thereby authenticated and the server will set the last known counter value at twenty.

In time-based synchronization methods, the token and server share the same internal clock. The shared clock increments or advances at the same rate. With each increment, a new response is generated. If the token and server responses match, the token response is authenticated. If the token response does not match the server response, the server will continue to calculate ahead within a predetermined synchronization range. If the token generates a response that matches the server response, within the predetermined range, the token response is authenticated by the server.

In a challenge-response system, a challenge is generated by the server and sent to the token. The token creates a response based on the challenge received from the server. Challenge-response systems do not have counter or time-off synchronization issues that are typically associated with time-based synchronization methods. The server calculates a response expected from the token, using an algorithm, or formula, based on the challenge and a predetermined shared secret that is also available to the token. If the token response and server response match, the token response is authenticated. Generation of the challenge can be from either the server or token.

In the methods described above, the counter, time synchronization, or challenge are generated by the token or the server, or both. In a counter-based system, the counter value is initiated by user action such as pressing a button. In a time synchronization based system, the token and server internal clocks increment, or advance, at the same rate. In a challenge-response system, the server may generate a challenge for the token to calculate and respond to.

Thus, a synchronization method for authenticating to a computer network system that utilizes publicly broadcast signals to synchronize both a client token and an authentication server, would be advantageous over the known prior art.

### BRIEF SUMMARY OF THE INVENTION

The present invention comprises a system and method for utilizing information in publicly broadcast signals. The invention utilizes information in publicly broadcast signals as a synchronization source for shared secret purposes, such as challenge and response. The invented system may use any suitable publicly broadcast signal as an information source. Such information may relate to time. Suitable publicly broadcast information may include, but is not limited to, GPS, radio clock information, atomic clock information, Greenwich Mean Time (or Z Time), Loran, and numerous other suitable information sources.

The system is comprised of a client token containing a unique algorithm or system running on the token's processor. The client token may be a physical device designed specifically for generation of responses based on internal seeds or shared secrets and public broadcast information. The client token may also be integrated into a separate device such as a cell phone or personal digital assistant (PDA). Both client and server must possess or have access to a system which is able to receive publicly broadcast signals or information.

If the device does not have built-in capability for receiving publicly broadcast signals, it may connect to another device which does contain such capability in order to receive the necessary information. The method of connecting to another device may include, but is not limited to, coupling through USB, or serial, wireless, infrared or specially designed devices allowing connection between the token and its host.

In cases where the client token is capable of receiving the publicly broadcast signal itself, the token may also transmit the response back to the server through the same means. However, the token may also be connected to a device or host. The device or host then sends the response back to the server for authentication.

Another example is a token connected to a device or host where the token is not capable of receiving publicly broadcast signals, but the device or host is capable of receiving such signals. The connection to the device or host allows the token to receive the publicly broadcast data. The token also utilizes the device or host to send responses to the server.

Another possible scenario is one where the token is capable of displaying the response for the user to input into on another device or system. The token may also be connected to a device or host that allows the response to be displayed. The user can then enter the displayed response value into any system required for authentication.

The server of this invention may also be designed to receive signals in ways similar to the client token. The server may be capable of receiving publicly broadcast signals, or be connected to a device which is able to receive publicly broadcast signals. The response can be received directly by the server or through a device the server is connected to.

The authentication server is provided with information indicating the unique algorithm, or other similar system, running on the token. Since the unique algorithm or system running on a particular token's processor is provided to the authentication server, the server can verify whether responses to challenges received by the token are in fact generated by that particular token.

Both the token and authentication server receive information from a designated source of publicly broadcast signals. The information received by the token is identical to the information received by the authentication server and, thus, can be used as a challenge. The token generates an answer or response to the challenge. The token's response is provided to the authentication server.

Since the unique algorithm or system running on the token's processor is provided to the authentication server, the authentication server can then verify that the response to the challenge received from the token is in fact generated by that unique token. If the response to the challenge is verified by the authentication server, the token is identified and authenticated.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, in which:

FIG. 1 is a schematic diagram showing a preferred embodiment of the system of the present invention.

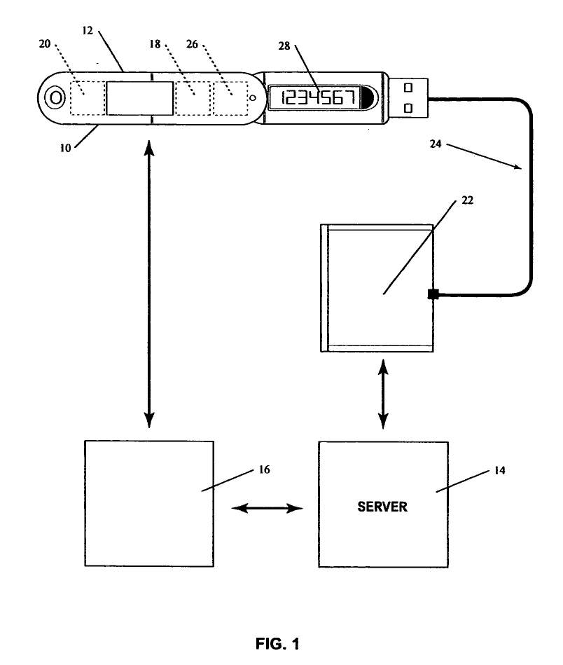

### DESCRIPTION OF THE PREFERRED EMBODIMENTS

The following description is provided to enable any person skilled in the art to make and use the invention and sets forth the best modes presently contemplated by the inventors of carrying out the invention. Various modifications, however, will remain readily apparent to those skilled in the art, since the generic principles of the present invention have been defined herein.

The present invention comprises a system and method for utilizing information in publicly broadcast signals. The invention may utilize information in publicly broadcast signals as a synchronization source for shared secret purposes, such as challenge and response purposes. The invented system may use any suitable publicly broadcast signal as an information source. Such information may relate to time. Suitable publicly broadcast information may include, but is not limited to, radio clock information, global positioning system information, atomic clock information, Greenwich Mean Time (or Z Time), Loran, and numerous other suitable information sources.

Referring to the drawing Figure, the invented system and method is shown generally at 10. The invention includes a hardware client token, shown generally at 12, an authentication server 14, and an information source 16.

The client token, hereinafter token 12, contains a processor 18 for processing data. The processor 18 is capable of running a unique algorithm, or other similar system, capable of generating answers, or responses, to challenges received by the token 12. These challenges can be in the form of information received from publicly broadcast signals that may be broadcast from the information source 16, as described above.

The token 12 also includes a memory 20 for storing data. Data and other information stored in the memory 20 may include internal seed data, portions of shared secrets, and other information.

The token 12 may be a stand-alone physical device designed specifically for generation of responses based on internal seeds or shared secrets and public broadcast information. Alternatively, the componetry and operating characteristics of the token 12 may be integrated into a separate device such as a known cellular phone or a Personal Digital Assistant (PDA), using known methods.

The token 12 must have the ability to receive publicly broadcast signals or information from the information source 16, via one or more known methods. For example, if the token 12 is not provided with built-in capability for receiving publicly broadcast signals, it may be connected to an external host device 22, such as a computer for example, which does contain such capability, in order to receive the information from the information source 16.

One method for coupling the token 12 to the external host device, or host device 22, may utilize well known Universal Serial Bus (USB) connectivity devices and techniques, shown generally at 24. Other methods for coupling the token 12 to an external device may include other known serial data connections, known and emerging wireless connectivity devices and techniques, and infrared devices and techniques, for example. Further, specially designed devices (not shown) may be provided for allowing the token 12 to couple to the host device 22.

When the token 12 is not provided with built-in capability for receiving publicly broadcast signals, the host device 22 receives the information from the information source 16 and transmits the information to the token 12 using one of the coupling techniques discussed above. The token 12 generates its response, and then transmits the response to the host device 22, so that the host device 22 can send the response to the server 16 for authentication.

The token 12 may be configured for directly receiving the publicly broadcast signals from the information source 16. In this embodiment, the token 12 may also transmit a response generated thereby to the server 14 through the same means. For example, the token 12 may be configured with a transceiver 26 for receiving publicly broadcast signals and then sending a response to the server 14.

In a further alternative embodiment, the token 12 may be capable of displaying the response. In this embodiment, the token 12 may be provided with a display 28 for displaying alphanumeric data representative of the response. The display 28 may comprise a known LCD display and may be fabricated using well known methods and techniques.

Once the response value is displayed on the display 28 of a token 12 a user possesses, the user may input the response value into an external device, which may or may not comprise the host device 22, or may comprise another system. Further alternatively, the token 12 may also be connected to a host device 22 that may allow the response value to be displayed on the device 22.

Once the response value is displayed on the device 22, the user can then enter the displayed response value into any system required for authentication.

In a manner similar to the token 12, the authentication server 14 is provided the ability to receive publicly broadcast signals or information from the information source 16, via one or more known methods. The authentication server 14 is also provided with information indicating the unique algorithm, or other similar system, running on the token 12. Since the unique algorithm or system running on a particular token's processor 18 is provided to the authentication server 14, the server 14 can verify whether responses to challenges received by the token 12 are in fact generated by that particular token.

Both the token 12 and authentication server 14 receive information from a designated information source 16. The information received by the token 12 is identical to the information received by the authentication server 14 and, thus, can be used as a challenge. The token 12 generates its response to the challenge. The token's response is provided to the authentication server 14.

Since the unique algorithm or system running on the token's processor 18 is provided to the authentication server 14, the authentication server 14 can then verify that the response to the challenge received from the token 12 is in fact generated by that unique token. If the response to the challenge is verified by the authentication server 14, the token 12 is identified and authenticated.

Those skilled in the art will appreciate that various adaptations and modifications of the just-described preferred embodiments can be configured without departing from the scope and spirit of the invention. Therefore, it is to be understood that, within the scope of the appended claims, the invention may be practiced other than as specifically described herein.

1. A system for utilizing information in publicly broadcast information as a synchronization source for shared secret purposes comprising:
a token device capable of receiving publicly broadcast information, the token device generating responses based on the publicly broadcast information; and
a server capable of receiving publicly broadcast information and receiving responses from the token device, the server generating challenges based on the publicly broadcast information and verifying the responses from the token to authenticate the token.

2. The system of claim 1 wherein the token device and server receive publicly broadcast information from a designated source.

3. The system of claim 2 wherein the designated source of publicly broadcast information is selected from the group consisting of radio clock information, global positioning system information, atomic clock information, Greenwich Mean Time information, and Loran information.

4. The system of claim 1 further comprising:
the token device provided with identifying information that indicates that particular token device and the identifying information contained in responses generated by the token.

5. The system of claim 4 further comprising:
the server generating challenges upon receiving responses from the token device, the server verifying the responses from the token device to authenticate the token and to determine a particular token device that generated the responses.

6. The system of claim 1 wherein the token device is a stand-alone device.

7. The system of claim 1 wherein the token device is made integral with a host device.

8. The system of claim 7 wherein the host device is selected from the group consisting of a cellular phone and a Personal Digital Assistant.

9. A method for utilizing publicly broadcast information as a synchronization source for shared secret purposes comprising:
publicly broadcasting information;
providing a token device capable of receiving publicly broadcast information and capable of generating responses based on the publicly broadcast information;
generating responses based on the publicly broadcast information;
providing a server capable of receiving publicly broadcast information and capable of generating challenges based on the publicly broadcast information;
transmitting responses to the server;
generating challenges based on the publicly broadcast information;
comparing responses to challenges for verifying the responses to authenticate the token device.

10. The method of claim 9 wherein the publicly broadcast information is broadcast from a designated source.

11. The method of claim 10 wherein the designated source of publicly broadcast information is selected from the group consisting of radio clock information, global positioning system information, atomic clock information, Greenwich Mean Time information, and Loran information.

12. The method of claim 9 wherein the token device provided is with identifying information that indicates that particular token device and the identifying information is contained in responses generated by the token.

13. The method of claim 12 wherein the server generating challenges upon receiving responses from the token device, the server verifying the responses from the token device to authenticate the token and to determine a particular token device that generated the responses.

14. The method of claim 9 wherein the token device is a stand-alone device.

15. The method of claim 9 wherein the token device is made integral with a host device.
